(19) United States
(12) Patent Application Publication
(10) Pub. No.: US 2025/0211777 A1
(43) Pub. Date: Jun. 26, 2025

(54) IMPLICIT MULTI-PASS DECODER-SIDE MOTION VECTOR REFINEMENT

(71) Applicant: MEDIATEK INC., Hsinchu City (TW)

(72) Inventors: Chen-Yen LAI, Hsinchu City (TW); Ching-Yeh CHEN, Hsinchu City (TW); Tzu-Der CHUANG, Hsinchu City (TW); Chun-Chia CHEN, Hsinchu City (TW); Chih-Wei HSU, Hsinchu City (TW)

(21) Appl. No.: 18/851,920

(22) PCT Filed: Apr. 6, 2023
(86) PCT No.: PCT/CN2023/086633

§ 371 Date: Sep. 27, 2024

Related U.S. Application Data
(60) Provisional application No. 63/327,913, filed on Apr. 6, 2022.

(51) Int. Cl. H04N 19/52; H04N 19/103; H04N 19/147; H04N 19/172; H04N 19/176; H04N 19/70

(52) U.S. Cl. CPC H04N 19/52; H04N 19/103; H04N 19/147; H04N 19/172; H04N 19/176; H04N 19/70

(57) ABSTRACT

A video coding system that uses implicit signaling for multiple-pass decoder-side motion vector refinement (MP-DMVR) is provided. A video coder receives data for a block of pixels to be encoded or decoded as a current block of a current picture of a video. The current block is associated with a first motion vector referring a first initial predictor and a second motion vector referring a second initial predictor. The video coder refines the first and second motion vectors to minimize first, second, and third costs according to first, second, and third refinement modes, respectively. The video coder selects a refinement mode based on a comparison of the first, second, and third costs. The video coder encodes or decodes the current block by using the selected refinement mode to modify the first and second motion vectors to reconstruct the current block.

### CROSS REFERENCE TO RELATED PATENT APPLICATION(S)

The present disclosure is part of a non-provisional application that claims the priority benefit of U.S. Provisional Patent Application No. 63/327,913, filed on 6 Apr. 2022. Contents of above-listed applications are herein incorporated by reference.

### TECHNICAL FIELD

The present disclosure relates generally to video coding. In particular, the present disclosure relates to decoder side motion vector refinement (DMVR).

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments provide a video coding system that uses implicit signaling for multiple-pass decoder-side motion vector refinement (MP-DMVR). A video coder receives data for a block of pixels to be encoded or decoded as a current block of a current picture of a video. The current block is associated with a first motion vector referring a first initial predictor in a first reference picture and a second motion vector referring a second initial predictor in a second reference picture. The video coder refines the first and second motion vectors to minimize first, second, and third costs according to first, second, and third refinement modes, respectively. The video coder selects a refinement mode based on a comparison of the first, second, and third minimized costs. The video coder encoding or decoding the current block by using the selected refinement mode to modify the first and second motion vectors for reconstructing the current block.

In some embodiments, the first minimized cost is computed based on a difference between a first refined predictor referenced by the refined first motion vector and the second initial predictor referenced by the second motion vector. The second minimized cost is computed based on a difference between a first initial predictor referenced by the first motion vector and a second refined predictor referenced by the refined second motion vector. The third minimized cost is computed based on a difference between the first refined predictor and the second refined predictor.

In some embodiments, the first minimized cost is computed based on a difference between a first blended-extended region and a neighboring region of current block, the first blended-extended region being a weighted sum of an extended region of the first refined predictor referenced by the refined first motion vector and an extended region of the second initial predictor referenced by the initial second motion vector. The second minimized cost is computed based on a difference between a second blended-extended region and the neighboring region of current block, the second blended-extended region being a weighted sum of an extended region of the second refined predictor referenced by the refined second motion vector and an extended region of the first initial predictor referenced by the first motion vector. The third minimized cost is computed based on a difference between a third blended-extended region and the neighboring region of current block, the third blended-extended region being a weighted sum of the extended region of the first refined predictor referenced by the refined first motion vector and the extended region of the second refined predictor referenced by the refined second motion vector.

In some embodiments, the first and second motion vectors are refined in one or more refinement passes, and the first, second, and third costs are computed after one refinement pass or two refinement passes. During the second refinement pass, the first and second motion vectors are refined for each sub-block of multiple sub-blocks of the current block. During the third refinement pass, the first and second motion vectors are refined by applying bi-directional optical flow (BDOF).

In some embodiments, the comparison of the costs is a weighted comparison. The selection may be implicit and the encoder does not signal any syntax element to the decoder to indicate the selection. In some embodiments, the encoder signals a syntax element (e.g., bm_merge_flag) indicating whether to use the first refinement mode; if not, the encoder compares the minimized second and third costs to determine whether to use the second refinement mode or the third refinement mode to encode the current picture. In some embodiments, the encoder signals a syntax element indicating whether to use the second refinement mode; if not, the encoder compares the minimized first and third costs to determine whether to use the first refinement mode or the third refinement mode to encode the current picture. In some embodiments, the encoder signals a syntax element indicating whether to use the third refinement mode; if not, the encoder compares the minimized first and second costs to determine whether to use the first refinement mode or the second refinement mode to encode the current picture.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates refinement of a prediction candidate by bilateral matching.

FIGS. 2A-B conceptually illustrate refining bi-prediction MVs under adaptive decoder-side motion vector refinement (DMVR).

FIGS. 3A-C conceptually illustrate the various types or modes of bilateral matching-based MV refinement.

FIGS. 4A-B conceptually illustrate generating an extended bilateral template based on extended prediction blocks that are referred by the refined MVs of list0 and list1.

FIG. 5 illustrates an example video encoder that may implement multi-pass DMVR.

FIG. 6 illustrates portions of the video encoder that implement multi-pass DMVR with implicit signaling.

FIG. 7 conceptually illustrates a process for performing multi-pass DMVR with implicit signaling.

FIG. 8 illustrates an example video decoder that may implement multi-pass DMVR.

FIG. 9 illustrates portions of the video decoder that implement multi-pass DMVR with implicit signaling.

FIG. 10 conceptually illustrates a process for performing multi-pass DMVR with implicit signaling.

FIG. 11 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Multi-Pass DMVR

In some embodiments, a multi-pass decoder-side motion vector refinement (MP-DMVR) method is applied in regular merge mode if the selected merge candidate meets the DMVR conditions. In the first pass, bilateral matching (BM) is applied to the coding block. In the second pass, BM is applied to each 16—16 subblock within the coding block. In the third pass, MV in each 8—8 subblock is refined by applying bi-directional optical flow (BDOF). The BM refines a pair of motion vectors MV0 and MV1 under the constraint that motion vector difference MVD0 (i.e., MV0′-MV0) is just the opposite sign of motion vector difference MVD1 (i.e., MV1′-MV1).

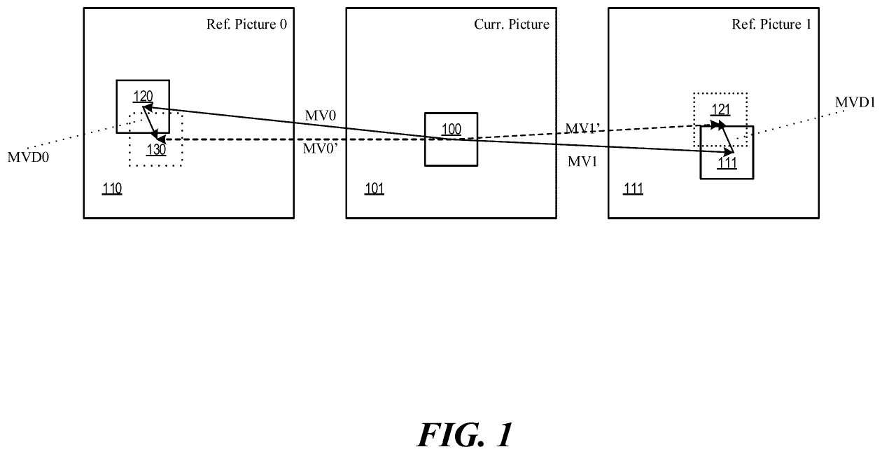

FIG. 1 conceptually illustrates refinement of a prediction candidate (e.g., merge candidate) by bilateral matching (BM). MV0 is an initial motion vector or a prediction candidate, MV1 is the mirror of MV0. MV0 references an initial reference block 120 in reference picture 110. MV1 references an initial reference block 121 in a reference picture 111. The figure shows MV0 and MV1 being refined to form MV0′ and MV1′, which reference updated reference blocks 130 and 131, respectively. The refinement is performed according to bilateral matching, such that the refined motion vector pair MV0′ and MV1′ has better bilateral matching cost than the initial motion vector pair MV0 and MV1. MV0′-MV0 (i.e., MVD0) and MV1′-MV1 (i.e., MVD1) are constrained to be equal in magnitude but opposite in direction. In some embodiments, the bilateral matching cost of a pair of mirrored motion vectors (e.g., MV0 and MV1) is calculated based on the difference between the two reference blocks referred by the mirrored motion vectors (e.g., difference between the reference blocks 110 and 111).

### II. Adaptive MP-DMVR

Adaptive decoder side motion vector refinement (Adaptive DMVR) method refines MV in only one of two directions of the bi-prediction (L0 and L1), for merge candidates that meet the DMVR conditions. Specifically, for a first unidirectional bilateral DMVR mode, L0 MV is modified or refined while L1 MV is fixed (so MVD1 is zero); for a second unidirectional DMVR, L1 MV is modified or refined while L0 MV is fixed (so MVD0 is zero).

The adaptive multi-pass DMVR process is applied for the selected merge candidate to refine the motion vectors, with either MVD0 or MVD1 being zero in the first pass of MP-DMVR (i.e., coding block or PU level DMVR.)

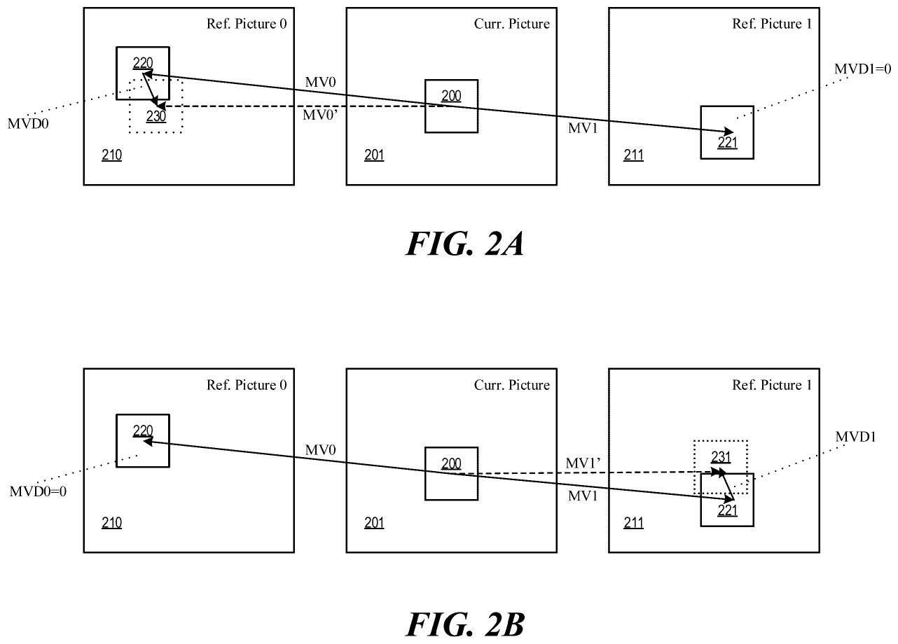

FIGS. 2A-B conceptually illustrate refining bi-prediction MVs under adaptive DMVR. The figures illustrate a current block 200 having initial bi-prediction MVs in L0 and L1 directions (MV0 and MV1). MV0 references an initial reference block 220 and MV1 references an initial reference block 221. Under adaptive DMVR, MV0 and MV1 are refined separately based on minimizing a cost that is calculated based on the difference between the reference blocks referred by MV0 and MV1.

FIG. 2A illustrates the first unidirectional bilateral DMVR modes in which only L0 MV is refined while L1 MV is fixed. As illustrated, MV1 remain fixed to reference the reference block 221, while MV0 is refined/updated to MV0′ to refer to an updated reference block 230 that is a better bilateral match for the fixed L1 reference block 221. FIG. 2B illustrates the second unidirectional bilateral DMVR mode in which only L1 MV is refined while L0 MV is fixed. As illustrated, MV0 remain fixed to reference the reference block 220, while MV1 is refined/updated to MV1′ to refer to an updated reference block 231 that is a better bilateral match for the fixed L0 reference block 220.

Similar to the regular merge mode DMVR, merge candidates for the two unidirectional bilateral DMVR modes are derived from the spatial neighboring coded blocks, TMVPs, non-adjacent blocks, HMVPs, and pair-wise candidate. The difference is that only merge candidates that meet DMVR conditions are added into the candidate list. The same merge candidate list is used by the two unidirectional bilateral DMVR modes, and their corresponding merge indices is coded as in regular merge mode. There are two syntax elements to indicate the adaptive MP-DMVR mode: bmMergeFlag and bmDirFlag. The syntax element bmMergeFlag is used to indicate the on-off of this type of prediction (refine MV only in one direction, or adaptive MP-DMVR). When bmMergeFlag is on, the syntax element bmDirFlag is used to indicate the refined MV direction. For example, when bmDirFlag is equal to 0, the refined MV is from List0; when bmDirFlag is equal to 1, the refined MV is from List 1. As shown in the following syntax table:

bm_merge_flag
if (bm_merge_flag)
bm_dir_flag

After decoding bm_merge_flag and bm_dir_flag, a variable bmDir can be decided. For example, if bm_merge_flag is equal to 1, bm_dir_flag is equal to 0, bmDir will be set as 1 to indicate that the adaptive MP-DMVR only refine the MV in List0 (or MV0). For another example, if bm_merge_flag is equal to 1, bm_dir_flag is equal to 1, bmDir will be set as 2 to indicate that the adaptive MP-DMVR only refine the MV in List1 (or MV1).

### III. Implicit MP-DMVR

### A. Implicit MP-DMVR Based on Costs

Implicit MP-DMVR refers to selection of one of three modes of MP-DMVR by encoder and decoder independently without explicit signaling some or all of adaptive MP-DMVR related syntax. The three modes of MP-DMVR correspond to the following three types or modes of bilateral matching-based MV refinement: MV refinement for L0 only, MV refinement for L1 only, and MV refinement for both L0 and L1.

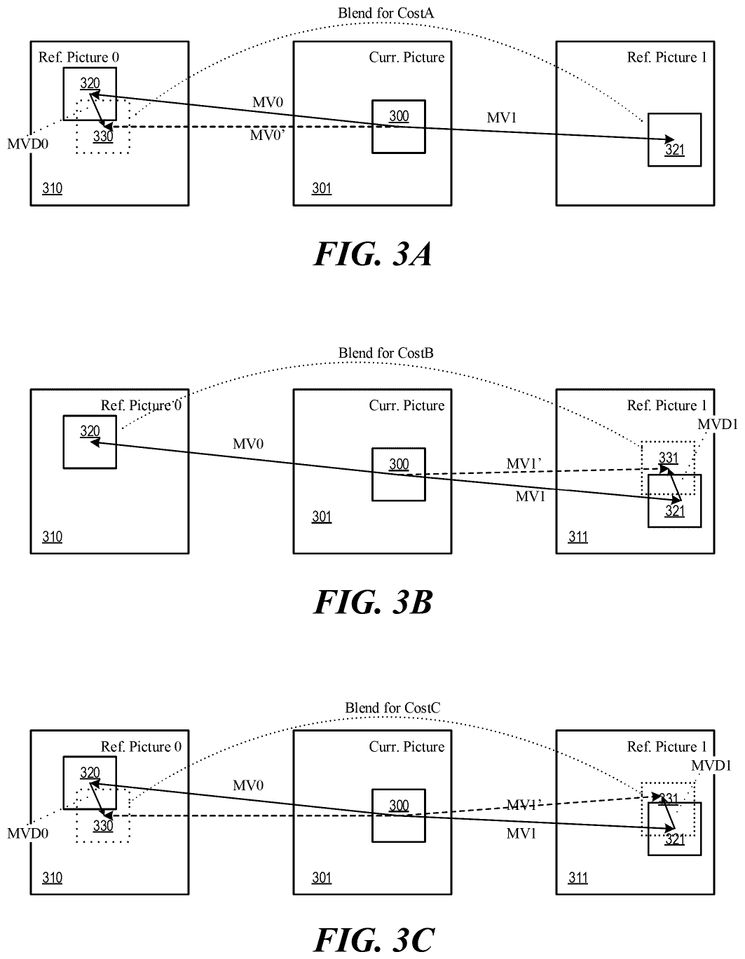

FIGS. 3A-C conceptually illustrate the various types or modes of bilateral matching-based MV refinement. The figures illustrate MV refinement for coding a current block 300. The current block 300 has two initial MVs (MV0 of L0 and MV1 of L1) that reference initial predictors or reference blocks 320 and 321. FIG. 3A illustrates MV refinement for L0 only (L0 adaptive bilateral matching, MVD1=0), where refined MV0=initial MV0+MV_offset, and refined MV1=initial MV1. FIG. 3B illustrates MV refinement for L1 only (L1 adaptive bilateral matching, MVD0=0), where refined MV0=initial MV0, and refined MV1=initial MV1+MV_offset. FIG. 3C illustrates MV refinement for both L0 and L1 (regular bilateral matching, MVD1=−MVD0), where refined MV0=initial MV0+MV_offset, and refined MV1=initial MV1−MV offset.

In some embodiment, implicit MP-DMVR is applied by using the costs derived during (adaptive) MP-DMVR, for each of the three modes (MV refinement for L0 only, L1 only, L0+L1). The lowest cost of the three modes will be implicitly chosen by encoder and decoder to perform DMVR. In some embodiments, implicit MP-DMVR is applied by using the costs derived from second pass of MP-DMVR. In some embodiments, implicit MP-DMVR is applied by using the costs derived during MP-DMVR pass 1 and pass 2.

FIGS. 3A-C also illustrate various costs of MP-DMVR first pass that are used for implicit DMVR. As illustrated in FIG. 3A (L0 only refinement), CostA is the matching cost between the refined L0 predictor 330 (referred by refined MV0′) and the fixed L1 predictor 321. As illustrated in FIG. 3B (L1 only refinement), CostB is the matching cost between the refined L1 predictor 331 (referred by refined MV1′) and the fixed L0 predictor 320. As illustrated in FIG. 3C (L0+L1 refinement), CostC is the bilateral matching cost between the refined L0 predictor 330 (referred by refined MV0′) and the refined L1 predictor 331 (referred by refined MV1′). The MV refinement having the smallest cost among CostA (L0 only), CostB (L1 only), and CostC (L0+L1) is used as the final MV refinement. For example, if CostA is the smallest of the three costs, then the final refined MV is derived by refining L0 MV only (with L1 MV fixed.) This method is performed in both encoder and decoder, so bm_merge_flag and bm_dir_flag are not signaled in some embodiments.

### B. Implicit MP-DMVR With Bm_Merge_Flag Signaling

In some embodiments, the signaling of MP-DMVR is partially implicit, specifically, by using the syntax element bm_merge_flag to indicate whether one of the refinement modes is selected; if not, one of the two remaining refinement modes is implicitly chosen based on cost.

For example, in some embodiments, the bm_merge_flag is used to indicate whether to refine MV on L1 only. If bm_merge_flag is equal to 1, the MV refinement is only for L1. If bm_merge_flag is equal to 0, the MV refinement is either only for L0 or for both L0 and L1. The decision is made by comparing CostA and CostC. Specifically, the MV refinement with smaller cost between CostA (L0 only) and CostC (bilateral matching using L0+L1) is used as the final MV refinement. For example, if CostA is the smaller of the two costs (CostA, CostC), then the final refined MV is derived by refining L0 MV only (with L1 MV fixed.) Conversely, if CostC is the smaller of the two costs, the final refined MV is derived by refining on both L0 and L1 (bilateral matching).

In some embodiments, the bm_merge_flag is used to indicate whether to refine MV on L0 only. If bm_merge_flag is equal to 1, the MV refinement is only for L0. If bm_merge_flag is equal to 0, the MV refinement is either only for L1, or for both L0 and L1. The decision of whether to refine MV for L1 only or for both L0 and L1 is made by comparing CostB and CostC. Specifically, the MV refinement having the smaller cost between CostB (L1 only) and CostC (bilateral matching; L0+L1) is used as the final MV refinement. For example, if CostB is the smaller of the two costs (CostB, CostC), then the final refined MV is derived by refining L1 MV only (with L0 MV fixed.) Conversely, if CostC is the smaller of the two costs (CostB, CostC), then the final refined MV is derived by refining both L0 and L1 MVs (bilateral matching).

In some embodiments, the bm_merge_flag is used to indicate whether to refine MV using regular bilateral matching, i.e., on both L0 and L1. If bm_merge_flag is equal to 1, the MV refinement is for both L0 and L1 using bilateral matching. If bm_merge_flag is equal to 0 (adaptive bilateral matching), the MV refinement is either for L0 only, or for L1 only. The decision of whether to refine MV for L0 only or for L1 only is made by comparing CostA and CostB. Specifically, the MV refinement having the smaller cost between CostA (L0 only) and CostB (L1 only) is used as the final MV refinement. For example, if CostA is the smallest of the two costs (CostA, CostB), then the final refined MV is derived by refining L0 MV only (with L1 MV fixed.) Conversely, if CostB is the smallest of the two costs (CostA, CostB), then the final refined MV is derived by refining L1 MV only (with L0 MV fixed.)

In some embodiments, the methods described in this section are performed in both encoder and decoder, so bm_dir_flag is not signaled.

### C. Implicit MP-DMVR With Weighting Cost

In some embodiments, the cost of refining MV on L0 only (CostA), the cost of refining MV on L1 only (CostB), and the cost of refining MVs on both L0 and L1 (CostC) can be weighed differently before comparison. For example, CostC can have a weight of 1, while CostA and/or CostB can have a weight of 1.05 when being compared. The result of the weighted comparison is used to determine whether to refine MVs on either only L0 (L0 adaptive bilateral matching), or only L1 (L1 adaptive bilateral matching) or both L0 and L1 (regular bilateral matching), based on which of CostA, CostB, and CostC is the smallest.

### D. Implicit MP-DMVR With Estimated Cost by Bi-Template

In some embodiments, an extended bilateral template (bi-template) is used to estimate the costs of MP-DMVR. The extended bilateral template is generated as the weighted combination of the two extended prediction blocks, from the refined MV0 of list0 (MV0′) and refined MV1 of list1 (MV1′). The estimated costs (CostA′, CostB′, and CostC′) can be used to implicitly signal MP-DMVR in place of the costs CostA, CostB, and CostC described above.

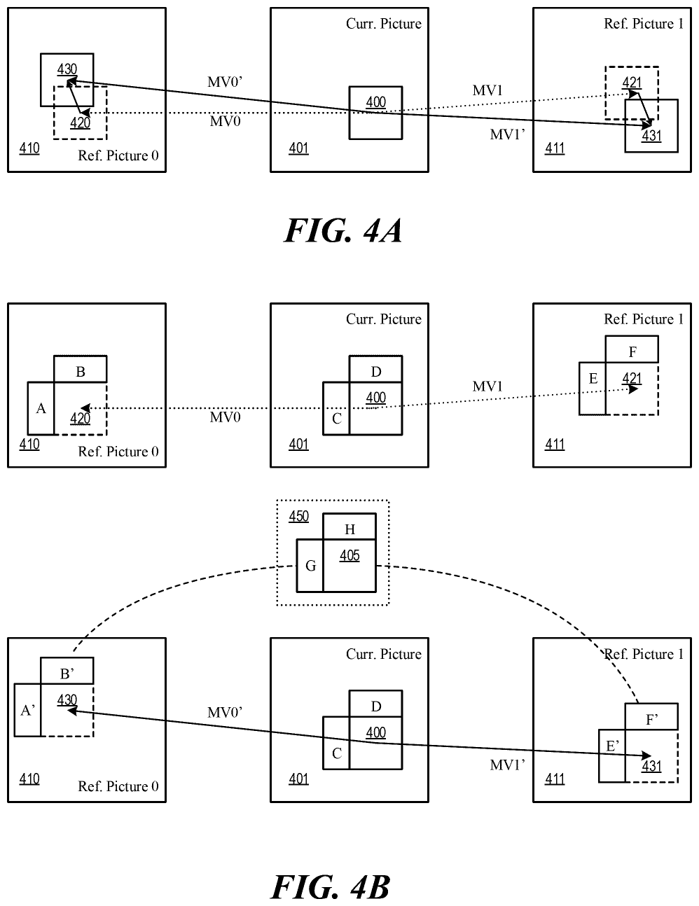

FIGS. 4A-B conceptually illustrate generating an extended bilateral template based on extended prediction blocks that are referred by the refined MVs of list0 and list1. FIG. 4A shows the refinement of MV0 and MV1 in a first pass and/or second pass of MP-DMVR. As illustrated, a current block 400 has an initial list0 MV (MV0) that references a L0 reference block 420 and an initial list1 MV (MV1) that references a L1 reference block 421. After MP-DMVR pass 1 (and/or pass 2), the current block 400 has a refined list0 MV (MV0′) that references a L0 reference block 430 and a refined list1 MV (MV1′) that references a L1 reference block 431.

FIG. 4B shows the extended regions that are used to compute various estimated costs for implicit signaling of MP-DMVR. The estimated costs are computed based on extended regions of the current block 400, extended regions of the initial L0 and L1 reference blocks 420 and 421, extended regions of the refined/updated L0 and L1 reference blocks 430 and 431, and extended regions of a bilateral template 405.

As illustrated, the initial L0 reference block 420 has extended regions A and B. The current block 400 has extended regions C and D. The initial L1 reference block 421 has extended regions E and F. The refined L0 reference block 430 has extended regions A′ and B′. The refined L1 reference block 431 has extended regions E′ and F′.

The video coder generates an extended bilateral template 450 by weighted sum from the extended L0 reference block (reference block 430 with A′ and B′) and extended L1 reference block (reference block 431 with E′ and F′). The extended bilateral template 450 includes a bilateral template 405 with extended regions G and H. The extended regions G and H can be computed as weighted sums of the extended regions A′ and B′ and the extended regions E′ and F′.

The template matching operation can be performed to calculate the costs (difference) between the extended region of the generated bilateral template and the sample regions (around the current block) in the current pictures. For example, N lines in region above current block 400 (extended region D) and the corresponding extended region in the generated bilateral template 450 (extended region H above bilateral template 405), as well as M lines in region left of current block 400 (extended region C) and the corresponding extended region in the generated bilateral template 450 (extended region G left of the bilateral template 405) can be used to calculate template matching cost. M and N can be any value larger than zero.

In some embodiments, the estimated cost CostA′ is computed based on a difference between a first blended-extended region and a neighboring region (C+D) of the current block, the first blended-extended region being a weighted sum of an extended region (A′+B′) of the first refined predictor 430 referenced by the refined first motion vector MV0′ and an extended region (E+F) of the second initial predictor 421 referenced by the initial second motion vector (MV1). CostB′ is computed based on a difference between a second blended-extended region and the neighboring region (C+D) of the current block, the second blended-extended region being a weighted sum of an extended region (E′+F′) of the second refined predictor 431 referenced by the refined second motion vector (MV1′) and an extended region (A+B) of the first initial predictor 420 referenced by the first initial motion vector (MV0). The third cost (CostC′) is computed based on a difference between a third blended-extended region and the neighboring region of current block, the third blended-extended region being a weighted sum of an extended region (A′+B′) of the first refined predictor 430 referenced by the refined first motion vector MV0′ and an extended region (E′+F′) of the second refined predictor 431 referenced by the refined second motion vector MV1′.

Any of the foregoing proposed methods can be implemented in encoders and/or decoders. For example, any of the proposed methods can be implemented in DMVR module of an encoder and/or a decoder. Alternatively, any of the proposed methods can be implemented as a circuit coupled to DMVR module of the encoder and/or the decoder.

### IV. Example Video Encoder

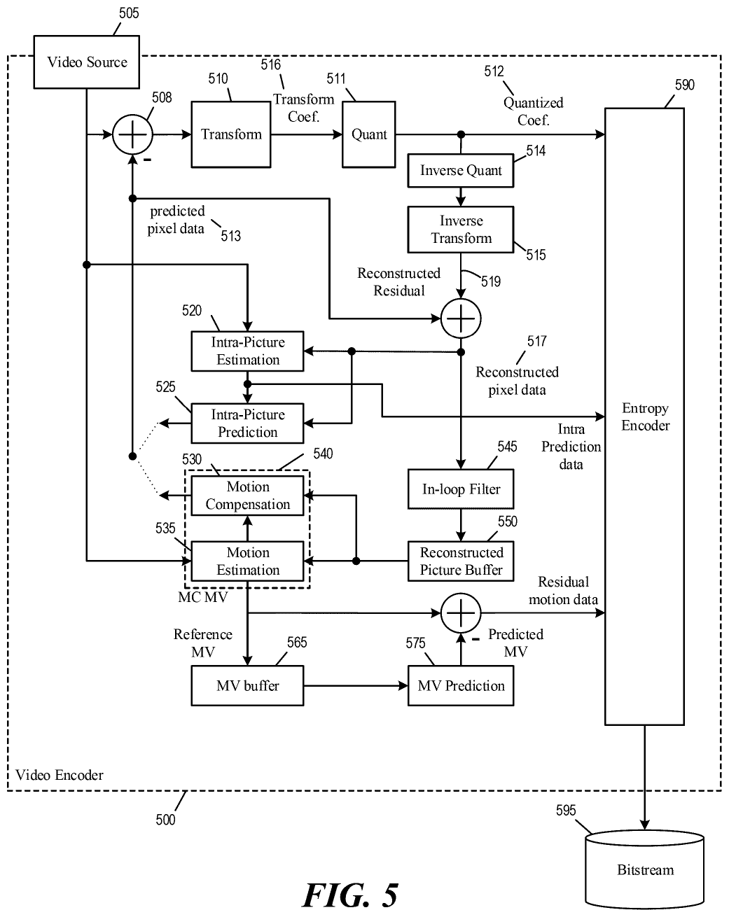

FIG. 5 illustrates an example video encoder 500 that may implement MP-DMVR. As illustrated, the video encoder 500 receives input video signal from a video source 505 and encodes the signal into bitstream 595. The video encoder 500 has several components or modules for encoding the signal from the video source 505, at least including some components selected from a transform module 510, a quantization module 511, an inverse quantization module 514, an inverse transform module 515, an intra-picture estimation module 520, an intra-prediction module 525, a motion compensation module 530, a motion estimation module 535, an in-loop filter 545, a reconstructed picture buffer 550, a MV buffer 565, and a MV prediction module 575, and an entropy encoder 590. The motion compensation module 530 and the motion estimation module 535 are part of an inter-prediction module 540.

In some embodiments, the modules 510-590 are modules of software instructions being executed by one or more processing units (e.g., a processor) of a computing device or electronic apparatus. In some embodiments, the modules 510-590 are modules of hardware circuits implemented by one or more integrated circuits (ICs) of an electronic apparatus. Though the modules 510-590 are illustrated as being separate modules, some of the modules can be combined into a single module.

The video source 505 provides a raw video signal that presents pixel data of each video frame without compression. A subtractor 508 computes the difference between the raw video pixel data of the video source 505 and the predicted pixel data 513 from the motion compensation module 530 or intra-prediction module 525. The transform module 510 converts the difference (or the residual pixel data or residual signal 508) into transform coefficients (e.g., by performing Discrete Cosine Transform, or DCT). The quantization module 511 quantizes the transform coefficients into quantized data (or quantized coefficients) 512, which is encoded into the bitstream 595 by the entropy encoder 590.

The inverse quantization module 514 de-quantizes the quantized data (or quantized coefficients) 512 to obtain transform coefficients, and the inverse transform module 515 performs inverse transform on the transform coefficients to produce reconstructed residual 519. The reconstructed residual 519 is added with the predicted pixel data 513 to produce reconstructed pixel data 517. In some embodiments, the reconstructed pixel data 517 is temporarily stored in a line buffer (not illustrated) for intra-picture prediction and spatial MV prediction. The reconstructed pixels are filtered by the in-loop filter 545 and stored in the reconstructed picture buffer 550. In some embodiments, the reconstructed picture buffer 550 is a storage external to the video encoder 500. In some embodiments, the reconstructed picture buffer 550 is a storage internal to the video encoder 500.

The intra-picture estimation module 520 performs intra-prediction based on the reconstructed pixel data 517 to produce intra prediction data. The intra-prediction data is provided to the entropy encoder 590 to be encoded into bitstream 595. The intra-prediction data is also used by the intra-prediction module 525 to produce the predicted pixel data 513.

The motion estimation module 535 performs inter-prediction by producing MVs to reference pixel data of previously decoded frames stored in the reconstructed picture buffer 550. These MVs are provided to the motion compensation module 530 to produce predicted pixel data.

Instead of encoding the complete actual MVs in the bitstream, the video encoder 500 uses MV prediction to generate predicted MVs, and the difference between the MVs used for motion compensation and the predicted MVs is encoded as residual motion data and stored in the bitstream 595.

The MV prediction module 575 generates the predicted MVs based on reference MVs that were generated for encoding previously video frames, i.e., the motion compensation MVs that were used to perform motion compensation. The MV prediction module 575 retrieves reference MVs from previous video frames from the MV buffer 565. The video encoder 500 stores the MVs generated for the current video frame in the MV buffer 565 as reference MVs for generating predicted MVs.

The MV prediction module 575 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 595 by the entropy encoder 590.

The entropy encoder 590 encodes various parameters and data into the bitstream 595 by using entropy-coding techniques such as context-adaptive binary arithmetic coding (CABAC) or Huffman encoding. The entropy encoder 590 encodes various header elements, flags, along with the quantized transform coefficients 512, and the residual motion data as syntax elements into the bitstream 595. The bitstream 595 is in turn stored in a storage device or transmitted to a decoder over a communications medium such as a network.

The in-loop filter 545 performs filtering or smoothing operations on the reconstructed pixel data 517 to reduce the artifacts of coding, particularly at boundaries of pixel blocks. In some embodiments, the filtering operation performed includes sample adaptive offset (SAO). In some embodiment, the filtering operations include adaptive loop filter (ALF).

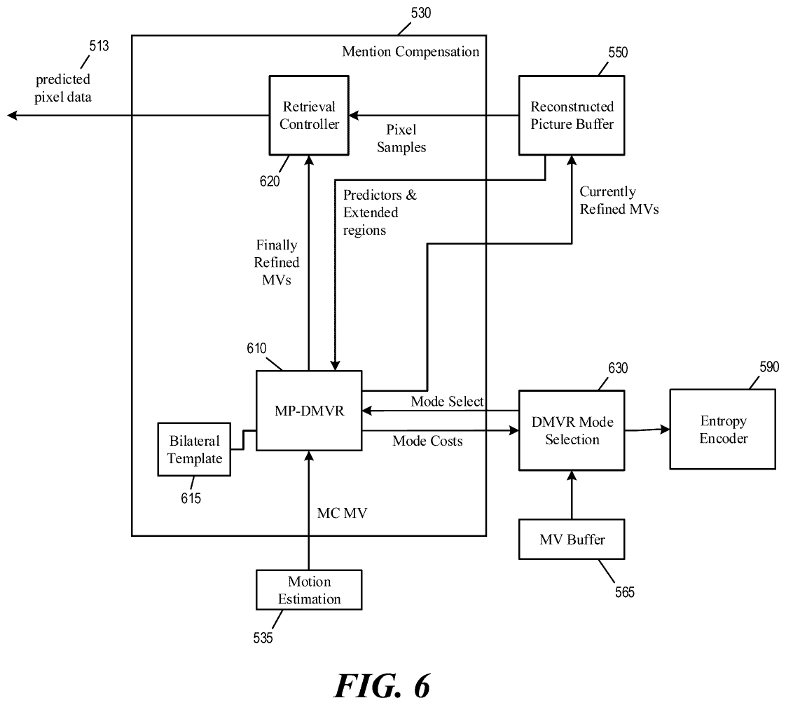

FIG. 6 illustrates portions of the video encoder 500 that implement MP-DMVR with implicit signaling. Specifically, the figure illustrates the components of the motion compensation module 530 of the video encoder 500. As illustrated, the motion compensation module 540 receives the motion compensation MV (MC MV) from the motion estimation module 535.

A MP-DMVR module 610 performs MP-DMVR process by using the MC MV as the initial or original MVs in L0 and/or L1 directions. The MP-DMVR module 610 refines the initial MVs into finally refined MVs in one or more refinement passes. The finally refined MVs is then used by a retrieval controller 620 to generate the predicted pixel data 513 based on content of the reconstructed picture buffer 550.

The MP-DMVR module 610 retrieves content of the reconstructed picture buffer 550. The content retrieved from the reconstructed picture buffer 550 includes predictors (or reference blocks) that are referred to by currently refined MVs (which may be the initial MVs, or any subsequent update). The retrieved content may also include extended regions of the current block and of the initial predictors. The MP-DMVR module 610 may use the retrieved content to calculate a bilateral template 615, including the extended regions of the bilateral template.

The MP-DMVR module 610 may use the retrieved predictors and the bilateral template 615 and/or their extended regions to calculate the costs for refining motion vectors, as described above in Sections IV above. The MP-DMVR module 610 may calculate the costs of various refinement modes, namely L0 only refinement (costA or costA′), L1 only refinement (costB or costB′), and L0+L1 bilateral matching refinement (costC or costC′). The calculated costs are provided to a DMVR mode selection module 630.

The DMVR mode selection module 630 may select one of the three refinement modes based on the provided costs. The signaling of the refinement mode selection may be partially implicit, such that the entropy encoder 590 may use the syntax element bm_merge_flag to indicate the selection of one of the three refinement modes as described above in Section III-B. The signaling of the refinement mode selection may also be entirely implicit based on costs as described in Section III-A above. The DMVR mode selection module 630 may weigh the costs of the three different refinement mode differently when using the costs to make the selection. The refinement mode selection is conveyed back to the MP-DMVR module 610 to continue MP-DMVR operations (e.g., additional refinement passes.)

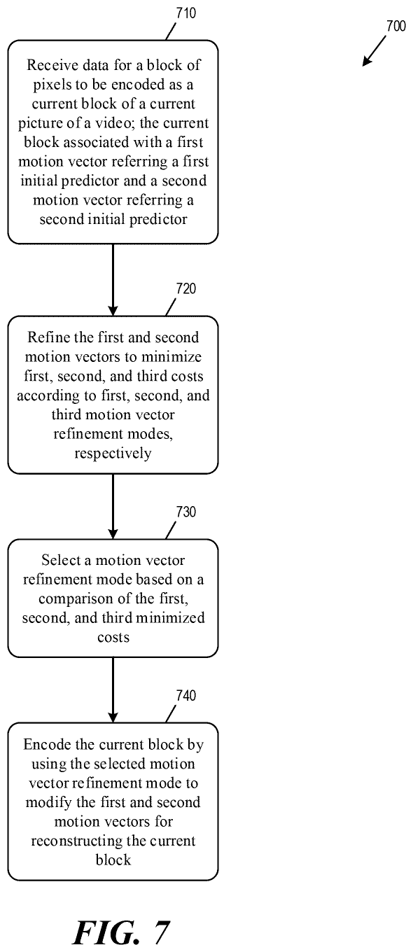

FIG. 7 conceptually illustrates a process 700 for performing MP-DMVR with implicit signaling. In some embodiments, one or more processing units (e.g., a processor) of a computing device implementing the encoder 500 performs the process 700 by executing instructions stored in a computer readable medium. In some embodiments, an electronic apparatus implementing the encoder 500 performs the process 700.

The encoder receives (at block 710) data for a block of pixels to be encoded as a current block of a current picture of a video. The current block is associated with a first motion vector (L0 MV) referring a first initial predictor in a first reference picture and a second motion vector (L1 MV) referring a second initial predictor in a second reference picture.

The encoder refines (at block 720) the first and second motion vectors to minimize first, second, and third costs according to first, second, and third refinement modes, respectively. In some embodiments, the first minimized cost (CostA for L0 refinement) is computed based on a difference between a first refined predictor referenced by the refined first motion vector and the second initial predictor referenced by the second motion vector. The second minimized cost (CostB for L1 only refinement) is computed based on a difference between a first initial predictor referenced by the first motion vector and a second refined predictor referenced by the refined second motion vector. The third minimized cost (CostC for L0+L1 refinement) is computed based on a difference between the first refined predictor and the second refined predictor.

In some embodiments, the first minimized cost (CostA′) is computed based on a difference between a first blended-extended region and a neighboring region of current block, the first blended-extended region being a weighted sum of an extended region of the first refined predictor referenced by the refined first motion vector and an extended region of the second initial predictor referenced by the initial second motion vector. The second minimized cost (CostB′) is computed based on a difference between a second blended-extended region and the neighboring region of current block, the second blended-extended region being a weighted sum of an extended region of the second refined predictor referenced by the refined second motion vector and an extended region of the first initial predictor referenced by the first motion vector. The third minimized cost (CostC′) is computed based on a difference between a third blended-extended region and the neighboring region of current block, the third blended-extended region being a weighted sum of the extended region of the first refined predictor referenced by the refined first motion vector and the extended region of the second refined predictor referenced by the refined second motion vector.

In some embodiments, the first and second motion vectors are refined in one or more refinement passes, and the first, second, and third costs are computed after one refinement pass or two refinement passes. During the second refinement pass, the first and second motion vectors are refined for each sub-block of multiple sub-blocks of the current block. During the third refinement pass, the first and second motion vectors are refined by applying bi-directional optical flow (BDOF).

The encoder selects (at block 730) a refinement mode based on a comparison of the first, second, and third minimized costs. In some embodiments, the comparison of the costs is a weighted comparison. The selection may be implicit and the encoder does not signal any syntax element to the decoder to indicate the selection. In some embodiments, the encoder signals a syntax element (e.g., bm_merge_flag) indicating whether to use the first refinement mode; if not, the encoder compares the minimized second and third costs to determine whether to use the second refinement mode or the third refinement mode to encode the current picture. In some embodiments, the encoder signals a syntax element indicating whether to use the second refinement mode; if not, the encoder compares the minimized first and third costs to determine whether to use the first refinement mode or the third refinement mode to encode the current picture. In some embodiments, the encoder signals a syntax element indicating whether to use the third refinement mode; if not, the encoder compares the minimized first and second costs to determine whether to use the first refinement mode or the second refinement mode to encode the current picture.

The encoder encodes (at block 740) the current block by using the selected refinement mode to reconstruct the current block. Specifically, the encoder may generate a finally refined motion vector by modifying the first and second motion vectors based on the selected refinement mode, and the finally refined motion vector is used to produce prediction residuals and to reconstruct the current block.

### V. Example Video Decoder

In some embodiments, an encoder may signal (or generate) one or more syntax element in a bitstream, such that a decoder may parse said one or more syntax element from the bitstream.

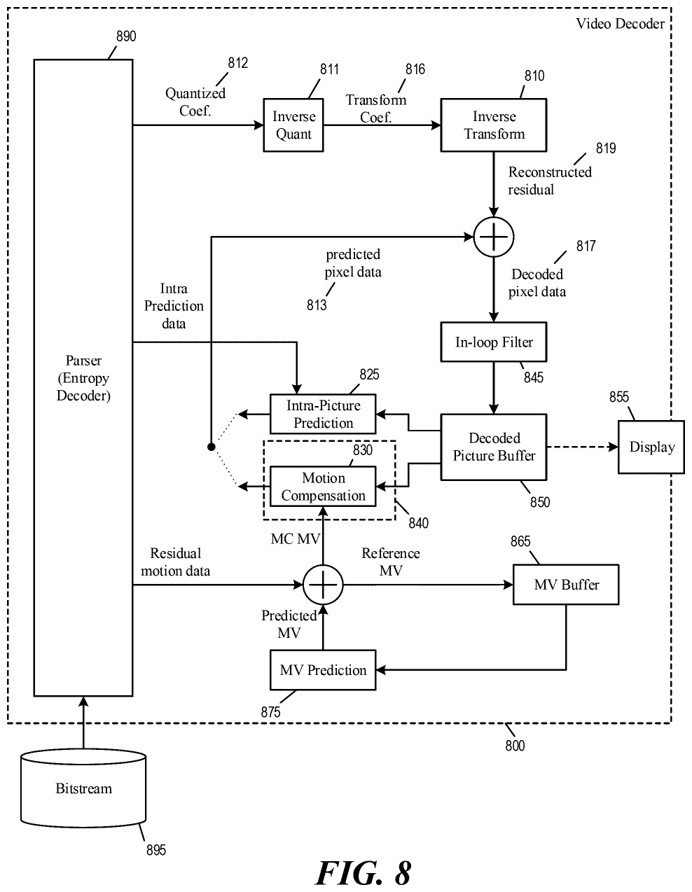

FIG. 8 illustrates an example video decoder 800 that may implement MP-DMVR. As illustrated, the video decoder 800 is an image-decoding or video-decoding circuit that receives a bitstream 895 and decodes the content of the bitstream into pixel data of video frames for display. The video decoder 800 has several components or modules for decoding the bitstream 895, including some components selected from an inverse quantization module 811, an inverse transform module 810, an intra-prediction module 825, a motion compensation module 830, an in-loop filter 845, a decoded picture buffer 850, a MV buffer 865, a MV prediction module 875, and a parser 890. The motion compensation module 830 is part of an inter-prediction module 840.

In some embodiments, the modules 810-890 are modules of software instructions being executed by one or more processing units (e.g., a processor) of a computing device. In some embodiments, the modules 810-890 are modules of hardware circuits implemented by one or more ICs of an electronic apparatus. Though the modules 810-890 are illustrated as being separate modules, some of the modules can be combined into a single module.

The parser 890 (or entropy decoder) receives the bitstream 895 and performs initial parsing according to the syntax defined by a video-coding or image-coding standard. The parsed syntax element includes various header elements, flags, as well as quantized data (or quantized coefficients) 812. The parser 890 parses out the various syntax elements by using entropy-coding techniques such as context-adaptive binary arithmetic coding (CABAC) or Huffman encoding.

The inverse quantization module 811 de-quantizes the quantized data (or quantized coefficients) 812 to obtain transform coefficients, and the inverse transform module 810 performs inverse transform on the transform coefficients 816 to produce reconstructed residual signal 819. The reconstructed residual signal 819 is added with predicted pixel data 813 from the intra-prediction module 825 or the motion compensation module 830 to produce decoded pixel data 817. The decoded pixels data are filtered by the in-loop filter 845 and stored in the decoded picture buffer 850. In some embodiments, the decoded picture buffer 850 is a storage external to the video decoder 800. In some embodiments, the decoded picture buffer 850 is a storage internal to the video decoder 800.

The intra-prediction module 825 receives intra-prediction data from bitstream 895 and according to which, produces the predicted pixel data 813 from the decoded pixel data 817 stored in the decoded picture buffer 850. In some embodiments, the decoded pixel data 817 is also stored in a line buffer (not illustrated) for intra-picture prediction and spatial MV prediction.

In some embodiments, the content of the decoded picture buffer 850 is used for display. A display device 855 either retrieves the content of the decoded picture buffer 850 for display directly, or retrieves the content of the decoded picture buffer to a display buffer. In some embodiments, the display device receives pixel values from the decoded picture buffer 850 through a pixel transport.

The motion compensation module 830 produces predicted pixel data 813 from the decoded pixel data 817 stored in the decoded picture buffer 850 according to motion compensation MVs (MC MVs). These motion compensation MVs are decoded by adding the residual motion data received from the bitstream 895 with predicted MVs received from the MV prediction module 875.

The MV prediction module 875 generates the predicted MVs based on reference MVs that were generated for decoding previous video frames, e.g., the motion compensation MVs that were used to perform motion compensation. The MV prediction module 875 retrieves the reference MVs of previous video frames from the MV buffer 865. The video decoder 800 stores the motion compensation MVs generated for decoding the current video frame in the MV buffer 865 as reference MVs for producing predicted MVs.

The in-loop filter 845 performs filtering or smoothing operations on the decoded pixel data 817 to reduce the artifacts of coding, particularly at boundaries of pixel blocks. In some embodiments, the filtering operation performed includes sample adaptive offset (SAO). In some embodiment, the filtering operations include adaptive loop filter (ALF).

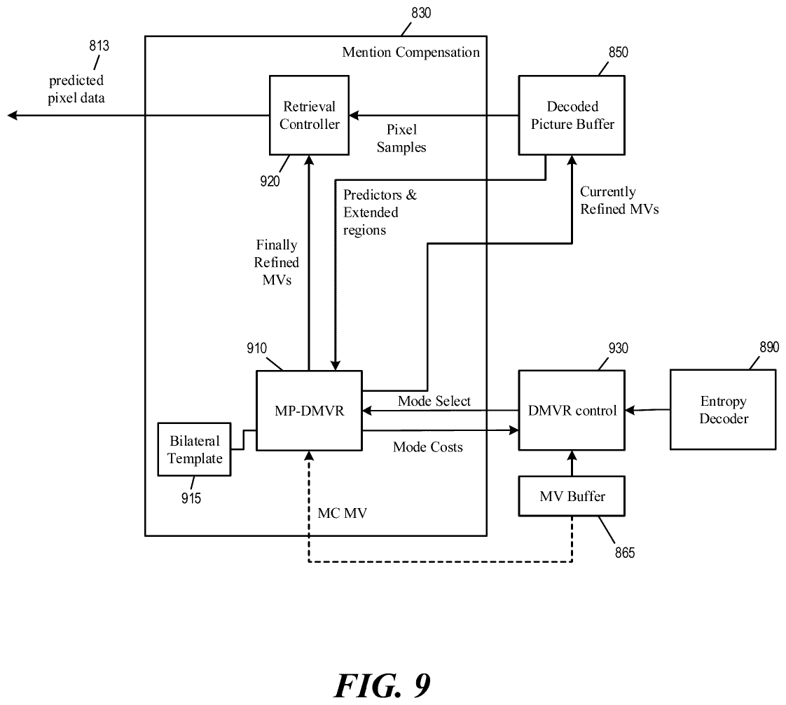

FIG. 9 illustrates portions of the video decoder 800 that implement MP-DMVR with implicit signaling. Specifically, the figure illustrates the components of the motion compensation module 830 of the video decoder 800. As illustrated, the motion compensation module 840 receives the motion compensation MV (MC MV) from the entropy decoder 890 or the MV buffer 865.

A MP-DMVR module 910 performs MP-DMVR process by using the MC MV as the initial or original MVs in L0 and/or L1 directions. The MP-DMVR module 910 refines the initial MVs into finally refined MVs in one or more refinement passes. The finally refined MVs is then used by a retrieval controller 920 to generate the predicted pixel data 813 based on content of the decoded picture buffer 850.

The MP-DMVR module 910 retrieves content of the decoded picture buffer 850. The content retrieved from the decoded picture buffer 850 includes predictors (or reference blocks) that are referred to by currently refined MVs (which may be the initial MVs, or any subsequent update). The retrieved content may also include extended regions of the current block and of the initial predictors. The MP-DMVR module 910 may use the retrieved content to calculate a bilateral template 915, including the extended regions of the bilateral template.

The MP-DMVR module 910 may use the retrieved predictors and the bilateral template 915 and/or their extended regions to calculate the costs for refining motion vectors, as described above in Sections IV above. The MP-DMVR module 910 may calculate the costs of various refinement modes, namely L0 only refinement (costA or costA′), L1 only refinement (costB or costB′), and L0+L1 bilateral matching refinement (costC or costC′). The calculated costs are provided to a DMVR mode selection module 930.

The DMVR mode selection module 930 may select one of the three refinement modes based on the provided costs. The signaling of the refinement mode selection may be partially implicit, such that the entropy decoder 890 may receive the syntax element bm_merge_flag to indicate the selection of one of the three refinement modes as described above in Section III-B. The signaling of the refinement mode selection may also be entirely implicit based on costs as described in Section III-A above. The DMVR mode selection module 930 may weigh the costs of the three different refinement mode differently when using the costs to make the selection. The refinement mode selection is conveyed back to the MP-DMVR module 910 to continue MP-DMVR operations (e.g., additional refinement passes.)

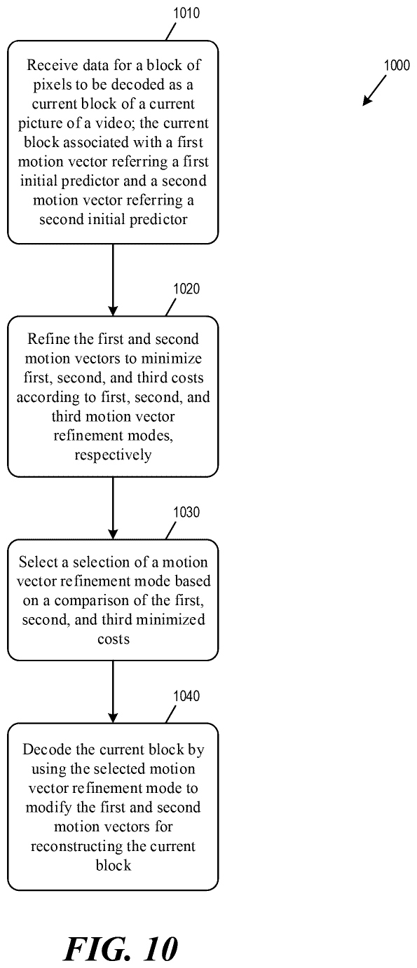

FIG. 10 conceptually illustrates a process 1000 for performing MP-DMVR with implicit signaling. In some embodiments, one or more processing units (e.g., a processor) of a computing device implementing the decoder 800 performs the process 1000 by executing instructions stored in a computer readable medium. In some embodiments, an electronic apparatus implementing the decoder 800 performs the process 1000.

The decoder receives (at block 1010) data for a block of pixels to be decoded as a current block of a current picture of a video. The current block is associated with a first motion vector (L0 MV) referring a first initial predictor in a first reference picture and a second motion vector (L1 MV) referring a second initial predictor in a second reference picture.

The decoder refines (at block 1020) the first and second motion vectors to minimize first, second, and third costs according to first, second, and third refinement modes, respectively. In some embodiments, the first minimized cost (CostA for L0 refinement) is computed based on a difference between a first refined predictor referenced by the refined first motion vector and the second initial predictor referenced by the second motion vector. The second minimized cost (CostB for L1 only refinement) is computed based on a difference between a first initial predictor referenced by the first motion vector and a second refined predictor referenced by the refined second motion vector. The third minimized cost (CostC for L0+L1 refinement) is computed based on a difference between the first refined predictor and the second refined predictor.

In some embodiments, the first minimized cost (CostA′) is computed based on a difference between a first blended-extended region and a neighboring region of current block, the first blended-extended region being a weighted sum of an extended region of the first refined predictor referenced by the refined first motion vector and an extended region of the second initial predictor referenced by the initial second motion vector. The second minimized cost (CostB′) is computed based on a difference between a second blended-extended region and the neighboring region of current block, the second blended-extended region being a weighted sum of an extended region of the second refined predictor referenced by the refined second motion vector and an extended region of the first initial predictor referenced by the first motion vector. The third minimized cost (CostC′) is computed based on a difference between a third blended-extended region and the neighboring region of current block, the third blended-extended region being a weighted sum of the extended region of the first refined predictor referenced by the refined first motion vector and the extended region of the second refined predictor referenced by the refined second motion vector.

In some embodiments, the first and second motion vectors are refined in one or more refinement passes, and the first, second, and third costs are computed after one refinement pass or two refinement passes. During the second refinement pass, the first and second motion vectors are refined for each sub-block of multiple sub-blocks of the current block. During the third refinement pass, the first and second motion vectors are refined by applying bi-directional optical flow (BDOF).

The decoder selects (at block 1030) a refinement mode based on a comparison of the first, second, and third minimized costs. In some embodiments, the comparison of the costs is a weighted comparison. The selection may be implicit and the decoder does not receive any syntax element to indicate the selection. In some embodiments, the decoder receives a syntax element (e.g., bm_merge_flag) indicating whether to use the first refinement mode; if not, the decoder compares the minimized second and third costs to determine whether to use the second refinement mode or the third refinement mode to decode the current picture. In some embodiments, the decoder receives a syntax element indicating whether to use the second refinement mode; if not, the decoder compares the minimized first and third costs to determine whether to use the first refinement mode or the third refinement mode to decode the current picture. In some embodiments, the decoder receives a syntax element indicating whether to use the third refinement mode; if not, the decoder compares the minimized first and second costs to determine whether to use the first refinement mode or the second refinement mode to decode the current picture.

The decoder decodes (at block 1040) the current block by using the selected refinement mode to reconstruct the current block. Specifically, the decoder may generate a finally refined motion vector by modifying the first and second motion vectors based on the selected refinement mode, and the finally refined motion vector is used to reconstruct the current block. The decoder may then provide the reconstructed current block for display as part of the reconstructed current picture.

### VI. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

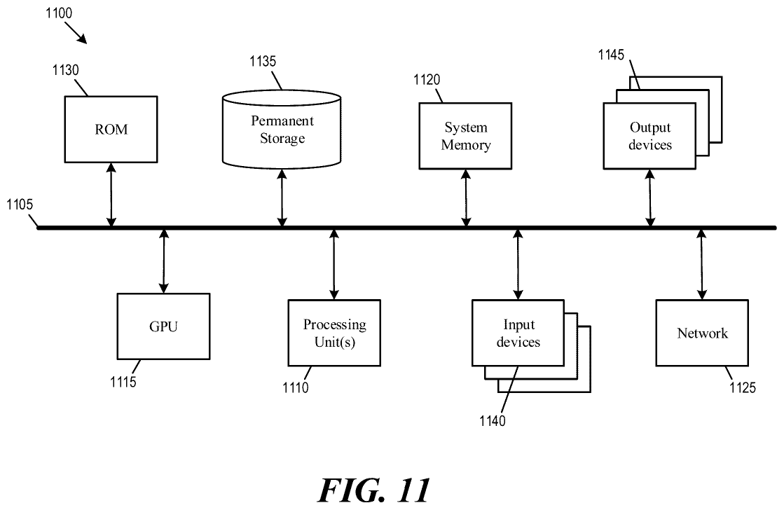

FIG. 11 conceptually illustrates an electronic system 1100 with which some embodiments of the present disclosure are implemented. The electronic system 1100 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1100 includes a bus 1105, processing unit(s) 1110, a graphics-processing unit (GPU) 1115, a system memory 1120, a network 1125, a read-only memory 1130, a permanent storage device 1135, input devices 1140, and output devices 1145.

The bus 1105 collectively represents all system, peripheral, and chipset buses that communicatively connect the numerous internal devices of the electronic system 1100. For instance, the bus 1105 communicatively connects the processing unit(s) 1110 with the GPU 1115, the read-only memory 1130, the system memory 1120, and the permanent storage device 1135.

From these various memory units, the processing unit(s) 1110 retrieves instructions to execute and data to process in order to execute the processes of the present disclosure. The processing unit(s) may be a single processor or a multi-core processor in different embodiments. Some instructions are passed to and executed by the GPU 1115. The GPU 1115 can offload various computations or complement the image processing provided by the processing unit(s) 1110.

The read-only-memory (ROM) 1130 stores static data and instructions that are used by the processing unit(s) 1110 and other modules of the electronic system. The permanent storage device 1135, on the other hand, is a read-and-write memory device. This device is a non-volatile memory unit that stores instructions and data even when the electronic system 1100 is off. Some embodiments of the present disclosure use a mass-storage device (such as a magnetic or optical disk and its corresponding disk drive) as the permanent storage device 1135.

Other embodiments use a removable storage device (such as a floppy disk, flash memory device, etc., and its corresponding disk drive) as the permanent storage device. Like the permanent storage device 1135, the system memory 1120 is a read-and-write memory device. However, unlike storage device 1135, the system memory 1120 is a volatile read-and-write memory, such a random access memory. The system memory 1120 stores some of the instructions and data that the processor uses at runtime. In some embodiments, processes in accordance with the present disclosure are stored in the system memory 1120, the permanent storage device 1135, and/or the read-only memory 1130. For example, the various memory units include instructions for processing multimedia clips in accordance with some embodiments. From these various memory units, the processing unit(s) 1110 retrieves instructions to execute and data to process in order to execute the processes of some embodiments.

The bus 1105 also connects to the input and output devices 1140 and 1145. The input devices 1140 enable the user to communicate information and select commands to the electronic system. The input devices 1140 include alphanumeric keyboards and pointing devices (also called “cursor control devices”), cameras (e.g., webcams), microphones or similar devices for receiving voice commands, etc. The output devices 1145 display images generated by the electronic system or otherwise output data. The output devices 1145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 11, bus 1105 also couples electronic system 1100 to a network 1125 through a network adapter (not shown). In this manner, the computer can be a part of a network of computers (such as a local area network (“LAN”), a wide area network (“WAN”), or an Intranet, or a network of networks, such as the Internet. Any or all components of electronic system 1100 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 7 and FIG. 10) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A video coding method comprising:
receiving data for a block of pixels to be encoded or decoded as a current block of a current picture of a video, the current block associated with a first motion vector referring a first initial predictor in a first reference picture and a second motion vector referring a second initial predictor in a second reference picture;
refining the first and second motion vectors to minimize first, second, and third costs according to first, second, and third refinement modes, respectively;
selecting a refinement mode based on a comparison of the first, second, and third minimized costs; and
encoding or decoding the current block by using the selected refinement mode to modify the first and second motion vectors for reconstructing the current block.

2. The video coding method of claim 1, wherein the first and second motion vectors are refined in one or more refinement passes, wherein the first, second, and third costs are computed after one refinement pass.

3. The video coding method of claim 1, wherein the first and second motion vectors are refined in one or more refinement passes, wherein the first, second, and third costs are computed after two refinement passes.

4. The video coding method of claim 3, wherein during a second refinement pass, the first and second motion vectors are refined for each sub-block of a plurality of sub-blocks of the current block in,
wherein during a third refinement pass, the first and second motion vectors are refined by applying bi-directional optical flow (BDOF).

5. The video coding method of claim 1, wherein the first, second, and third minimized costs are weighted before the comparison.

6. The video coding method of claim 1, wherein:
the first minimized cost is computed based on a difference between a first refined predictor referenced by the refined first motion vector and the second initial predictor,
the second minimized cost is computed based on a difference between a second refined predictor referenced by the refined second motion vector and the first initial predictor, and
the third minimized cost is computed based on a difference between the first refined predictor and the second refined predictor.

7. The video coding method of claim 6, further comprising:
signaling or receiving a syntax element indicating whether to use the first refinement mode; and
comparing the minimized second and third costs to determine whether to use the second refinement mode or the third refinement mode to encode or decode the current picture.

8. The video coding method of claim 6, further comprising:
signaling or receiving a syntax element indicating whether to use the second refinement mode; and
comparing the minimized first and third costs to determine whether to use the first refinement mode or the third refinement mode to encode or decode the current picture.

9. The video coding method of claim 6, further comprising:
signaling or receiving a syntax element indicating whether to use the third refinement mode; and
comparing the minimized first and second costs to determine whether to use the first refinement mode or the second refinement mode to encode or decode the current picture.

10. The video coding method of claim 1, wherein:
the first minimized cost is computed based on a difference between a first blended-extended region and a neighboring region of the current block, wherein the first blended-extended region is a weighted sum of an extended region of a first refined predictor referenced by the refined first motion vector and an extended region of the second initial predictor,
the second minimized cost is computed based on a difference between a second blended-extended region and the neighboring region of the current block, wherein the second blended-extended region is a weighted sum of an extended region of a second refined predictor referenced by the refined second motion vector and the first initial predictor, and
the third minimized cost is computed based on a difference between a third blended-extended region and the neighboring region of the current block, wherein the third blended-extended region is a weighted sum of an extended region of the first refined predictor and the extended region of the second refined predictor.

11. An electronic apparatus comprising:
a video coder circuit configured to perform operations comprising:
receiving data for a block of pixels to be encoded or decoded as a current block of a current picture of a video, the current block associated with a first motion vector referring a first initial predictor in a first reference picture and a second motion vector referring a second initial predictor in a second reference picture;
refining the first and second motion vectors to minimize first, second, and third costs according to first, second, and third refinement modes, respectively;
selecting a refinement mode based on a comparison of the first, second, and third minimized costs; and
encoding or decoding the current block by using the selected refinement mode to modify the first and second motion vectors for reconstructing the current block.

12. A video decoding method comprising:
receiving data for a block of pixels to be decoded as a current block of a current picture of a video, the current block associated with a first motion vector referring a first initial predictor in a first reference picture and a second motion vector referring a second initial predictor in a second reference picture;
refining the first and second motion vectors to minimize first, second, and third costs according to first, second, and third refinement modes, respectively;
selecting a refinement mode based on a comparison of the first, second, and third minimized costs; and
decoding the current block by using the selected refinement mode to modify the first and second motion vectors for reconstructing the current block.

13. (canceled).
